(19) United States
(12) Patent Application Publication
(10) Pub. No.: US 2026/0168522 A1
(43) Pub. Date: Jun. 18, 2026

(54) TELESCOPIC CYLINDER WITH A FEED/DISCHARGE CONDUIT OF VARIABLE LENGTH

(71) Applicant: MANITOU ITALIA S.R.L., CASTELFRANCO EMILIA (MODENA) (IT)

(72) Inventor: MARCO IOTTI, REGGIO EMILIA (IT)

(21) Appl. No.: 19/420,439

(22) Filed: Dec. 15, 2025

(30) Foreign Application Priority Data
Dec. 17, 2024 (IT) 102024000028659

(51) Int. Cl. F15B 15/16; F15B 15/14

(52) U.S. Cl. CPC F15B 15/16; F15B 15/149; F15B 2215/30

(57) ABSTRACT

A telescopic cylinder that includes a first cylinder having a first piston slidable in a jacket which has an extension chamber and a re-entry chamber, separated from each other by a head of the first piston and a second cylinder having a second piston slidable in a sealed fashion in a second jacket which has an extension chamber and a re-entry chamber, separated from each other by a head of the second piston. The jacket of the first piston is integral with the second piston. The telescopic cylinder further has an outer conduit, connected to the re-entry chamber of the second cylinder for allowing the supply and discharge of oil. The outer conduit has a first body having a first slider and a second body having a second slider, wherein the first slider has a first inner channel and the second slider has a second inner channel.

This invention relates to a telescopic cylinder provided with a feed/discharge conduit designed to adapt its length to the configuration adopted by the telescopic cylinder.

The invention may be used, but not exclusively, for actuating a telescopic arm used in an operating machine, such as, for example, a telehandler, manipulator, lift truck, aerial platform, both of the fixed type and of the rotary type.

These operating machines are used in various sectors, from building works, to farming, to mining, etc. and include a vehicle provided with a frame movable on tracks or on wheels, which mounts a lifting arm which can be extended telescopically and may or may not mount a driver's cab.

At the distal end of the arm there is an apparatus for lifting or moving loads, which comprises a tool such as a fork, a gripper, etc.

The arm is articulated to the frame or to a rotary platform of the machine and is designed to rotate from a lower position, substantially horizontal, to an upper position wherein the arm is close to the vertical. The rotation of the arm is achieved by means of actuators such as hydraulic cylinders or the like.

The arm comprises two or more sliding segments, tubular in shape and with a decreasing cross-section, which are connected in a telescopic fashion.

Solutions are known wherein at least the first two sliding members of the arm, that is to say, the sliding member closest to the axis of rotation of the arm and the sliding member immediately following it, are slidably driven by a telescopic cylinder with double sliding member. These solutions use a telescopic cylinder comprising a first cylinder and a second cylinder, wherein the piston of the second cylinder houses the sliding chamber of the piston of the first cylinder. The two cylinders are fed independently of each other so that each can slide independently of each other. The possibility of controlling the two sliding members independently may be useful, for example, for moving the overall barycentre of the arm under certain conditions of use.

In the solutions wherein the telescopic arm adopts a significant length, the prior art teaches structuring the feed circuit for the telescopic cylinder with inner conduits, that is to say, conduits which are made in the thickness of the pistons. In some cases, or for specific architectures of the oil feed circuit, one or more conduits must be outside the cylinders. In these cases, the outer conduits must often have a considerable length, resulting in a series of drawbacks in terms of size and support of the conduits.

The aim of this invention is to provide a telescopic cylinder provided with at least one outer feed/discharge conduit which makes it possible to overcome the drawbacks of the telescopic cylinders currently available.

The main advantage of the telescopic cylinder according to this invention is that the outer conduit adopts and maintains a rectilinear configuration, being able to automatically adapt to the length adopted, instant by instant, by the telescopic cylinder.

Further features and advantages of the invention are more apparent from the detailed description which follows of an embodiment of the invention, illustrated by way of a non-limiting example in the accompanying drawings in which:

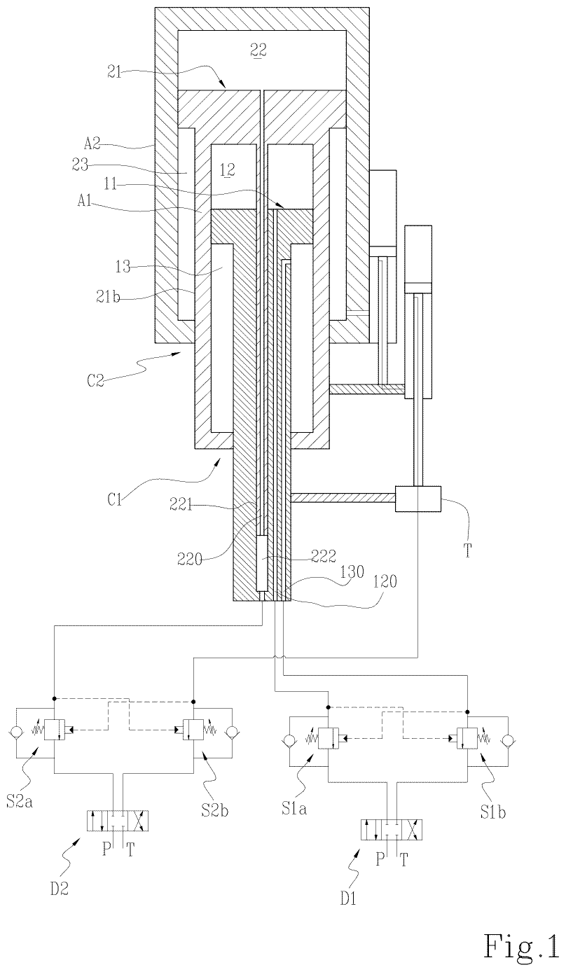

FIG. 1 shows a schematic view of a telescopic cylinder according to this invention, associated with a circuit for feeding operating fluid;

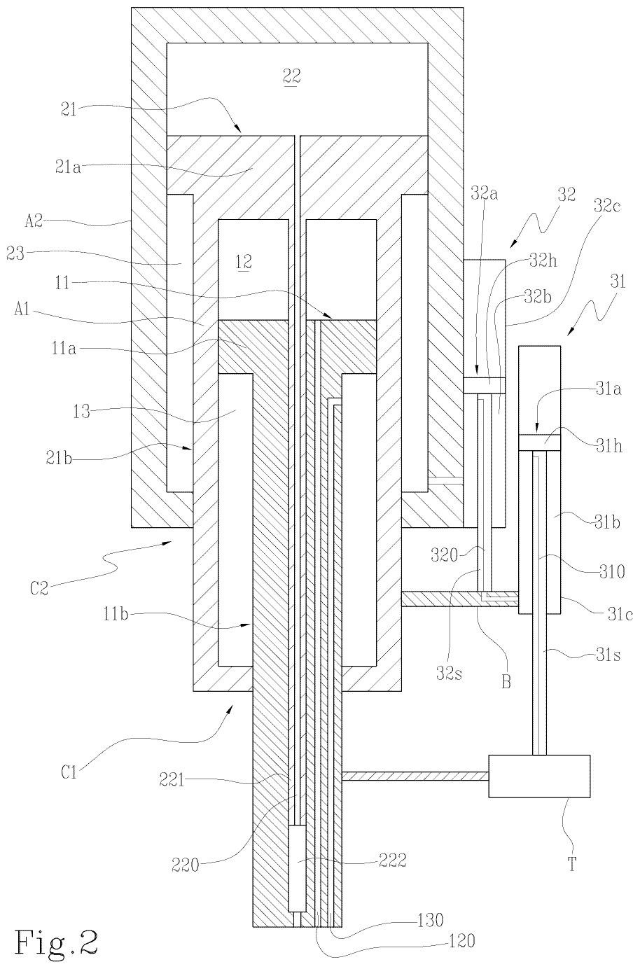

FIG. 2 shows an enlarged schematic view of the telescopic cylinder of FIG. 1;

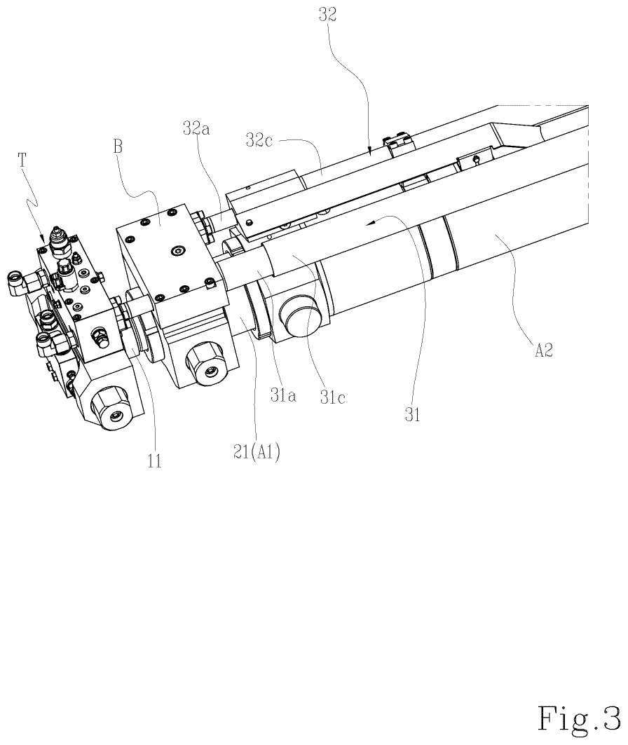

FIG. 3 shows an isometric view of a part of the telescopic cylinder according to this invention;

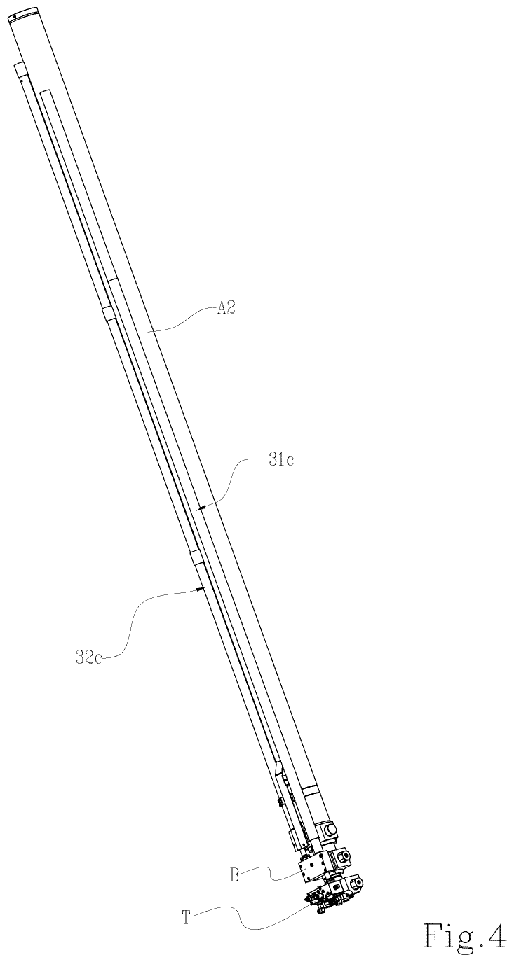

FIG. 4 shows an overall isometric view of the telescopic cylinder according to this invention;

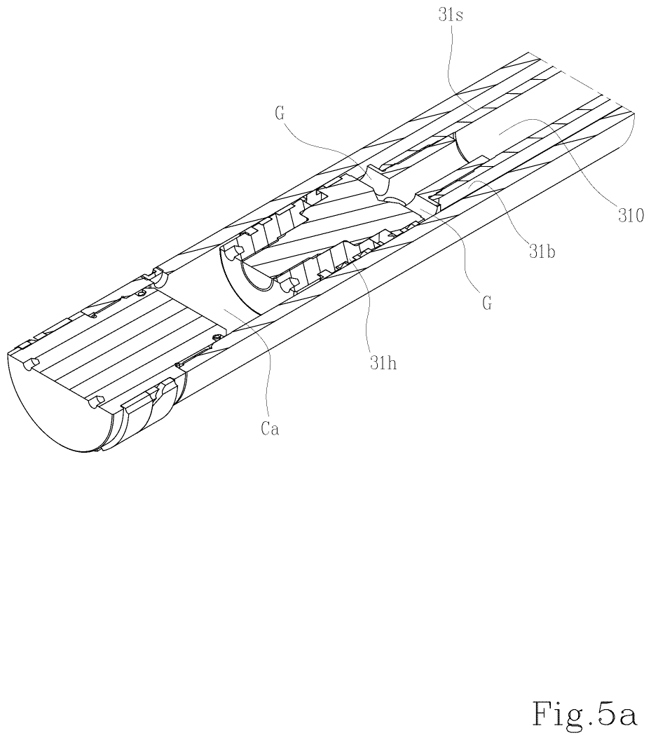

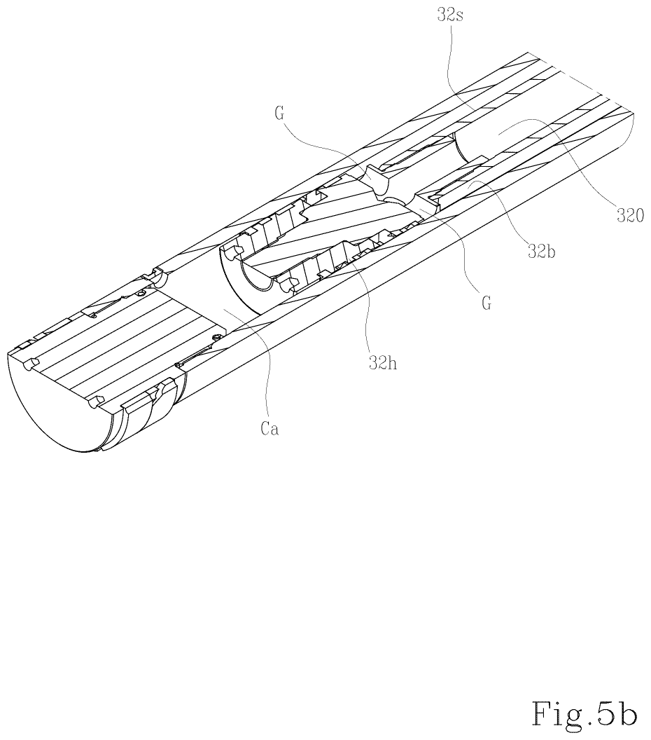

FIGS. 5a and 5b show cross sections of two details of the telescopic cylinder according to this invention.

The solution described in this invention relates to a telescopic cylinder which comprises a first cylinder (C1) and a second cylinder (C2) fed independently from each other. The solution might, however, also be extended to telescopic cylinders comprising a greater number of cylinders fed independently of each other. The relative sliding between the two cylinders is obtained, in known manner, by coordinated feeding and discharging of an operating fluid, that is to say, oil.

The telescopic cylinder according to this invention comprises a first cylinder (C1) and a second cylinder (C2), connected telescopically to each other.

Preferably, the first cylinder (C1), comprises a first piston (11) slidable in a sealed fashion in a jacket (A1) which comprises an extension chamber (12) and a re-entry chamber (13), separated from each other by a head (11a) of the first piston (11). In a manner known in the sector, the first piston (11) comprises a rod (11b), connected to the head (11a) and protruding outside the jacket (A1). The rod (11b) is designed to be connected to a fixed part of the machine. The feeding of operating fluid, that is to say, oil, to the extension chamber (12) results in a movement of the rod (11b) coming out from the jacket (A1), whilst the feeding of oil to the re-entry chamber (13) results in a movement of the rod (11b) re-entering the jacket (A1).

The second cylinder (C2), comprises, in turn, a second piston (21) slidable in a sealed fashion in a jacket (A2) which comprises an extension chamber (22) and a re-entry chamber (23), separated from each other by a head (21a) of the second piston (21). The jacket (A1) of the first piston (11) is integral with the second piston (21). In particular, the jacket (A1) of the first piston (11) forms at least partly a rod (21b) of the second piston (21), which protrudes from the jacket (A2) of the second cylinder (C2). The feeding of pressurised oil to the extension chamber (22) results in a movement of the rod (21b) coming out from the jacket (A2), whilst the feeding of pressurised oil to the re-entry chamber (23) results in a movement of the rod (21b) re-entering the jacket (A1).

Both the pistons (11, 21), and the jackets (A1, A2), are concentric to a longitudinal axis (X) and are movable relative to each other along the longitudinal axis (X).

The extension and re-entry chambers (12, 13) of the first cylinder (C1) are connected to a feed circuit of known type, which comprises, for example, a proportional four-way distributor (D1), designed to determine the feeding of oil to the extension chamber (12) or the re-entry chamber (13) and, simultaneously, to put in communication with a drain the chamber which is not supplied with the oil. In the embodiment illustrated, the distributor (D1) is provided with a drawer or shutter which may adopt an extension position, in which the extension chamber (12) is in communication with a source of high pressure fluid, for example a pump (P), and the re-entry chamber (13) is in communication with a drain. This first position is schematically shown on the left-hand side of the distributor (D1). The drawer may also adopt a re-entry position, schematically illustrated on the right-hand side of the distributor (D1), in which opposite connections are made relative to those of the first position. The drawer may also adopt a central position in which the chambers (12, 13) are not in communication with the pump (P). The circuit also comprises two valves for controlling the load (S1a, S1b), of known type, connected, respectively, to the extension chamber (12) and to the re-entry chamber (13), designed to allow the discharge of oil from the respective chamber (12, 13) only in the presence of a specific command which moves them into an open configuration. According to the embodiment described, the specific command is obtained in the form of a control pressure picked up from a branch of the circuit connected to the opposite chamber 12, 13.

The extension and re-entry chambers (22, 23) of the second cylinder (C2) are connected to a feed circuit similar to that described above, with a distributor (D2) and load control valves (S2a, S2b) similar and operational as described above in relation to the first cylinder (C1).

Each distributor (D1, D2) can be activated independently of the other, so that each cylinder (C1, C2) can be controlled independently from the other.

In a manner known in the sector, the commands for extension and re-entry of each cylinder may be issued using an operating unit or an interface which can be activated by an operator. The operating unit comprises, for example, an electric joystick, one or more pushbuttons or the like. The extension or re-entry command causes the movement of the respective distributor (D1, D2) to the position corresponding to the requested action. The commands sent to the proportional distributors (D1, D2) may be of any type, for example of the electro-hydraulic type, for controlling a control pressure, or direct electrical type.

According to the embodiment illustrated, the extension chamber (12) of the first cylinder (C1) is connected to the feed circuit by a first conduit (120), made through the first piston (11). The re-entry chamber (13) of the first cylinder (C1) is connected to the feed circuit by a second conduit (130), also made through the first piston (11).

According to the preferred but not exclusive embodiment illustrated, the re-entry chamber (23) of the second cylinder (C2) is connected to the feed circuit of the second cylinder (C2) by an outer conduit, schematically illustrated in FIG. 1.

The telescopic cylinder also comprises a first conduit (220) for connection to the extension chamber (22) of the second cylinder (C2). The connecting conduit (220) is made at least partly through the first piston (11) and the second piston (12). According to the embodiment illustrated, the connecting conduit (220) comprises a tubular element (221), integral with the second piston (12) and protruding concentrically with the longitudinal axis (X) through the first piston (11). The latter has a seat (222) in which the tubular body can slide in a sealed fashion. The seat (222), in turn, has an opening for connection to the feed circuit of the second cylinder (C2). The feeding of oil to the extension chamber (12) of the first cylinder (C1) results in a relative sliding between the tubular element (221) and the seat (222).

In any case, the invention may advantageously be used in solutions wherein the cylinders are served by at least one outer feed/discharge conduit.

The telescopic cylinder according to the invention comprises an outer conduit (31, 32) connected to the re-entry chamber (23) of the second cylinder (C2) for allowing the feeding and discharge of oil.

The outer conduit (31, 32) comprises a first body (31) and a second body (32), each of which has a telescopic structure. In particular, each of the two elements (31, 32) can be extended and shortened in a synchronised manner with the movements of extension and re-entry of the two cylinders (C1, C2). For this purpose, the first body (31) is constrained to the first cylinder (C1), whilst the second body (32) is constrained to the second cylinder (C2). Moreover, a slidable part of the first body (31) is constrained to a slidable part of the second body (32), by a direct or indirect constraint. In this way, the relative sliding between the two cylinders (C1, C2) draws the first body (31) and the second body (32) in a relative sliding fashion. This allows the length of the outer conduit (31, 32) to be adapted, instant by instant, to the relative position between the two cylinders (C1, C2), without the need to provide flexible conduits which would adopt, depending on the position of the two cylinders (C1, C2), curved and unstable configurations, which could interfere with the movements of the cylinders.

According to a preferred embodiment, the first body (31) comprises a first slider (31a) slidable in a sealed fashion in a first sleeve (31c) which encloses a first chamber (31b). The first sleeve (31c) is constrained to the second piston (21). The first slider (31a) is constrained to a fixed part relative to the sliding of the two cylinders (C1, C2).

In turn, the second body (32) comprises a second slider (32a) slidable in a sealed fashion in a second sleeve (32c) which encloses a second chamber (32b). The second sleeve (32c) is constrained to the second jacket (A2). The second chamber (32b) is in fluid communication with the re-entry chamber (23) of the second cylinder (C2). Moreover, the second slider (32a) is constrained to the first sleeve (31b). In the embodiment illustrated in FIG. 2, both the first sleeve (31b) and the second slider (32a) are connected to the second piston (21), and are therefore connected to each other. In the embodiment shown in FIG. 2, the second slider (32a) is, on the other hand, constrained directly to the first sleeve (31b).

According to the preferred but non-exclusive embodiment illustrated, the first slider (31a) is substantially piston-shaped, with a head (31h) slidable in a sealed fashion in the first sleeve (31c). The head (31h) substantially divides the volume inside the sleeve (31c) into two separate chambers. One is the first chamber (31b). A second chamber, on the opposite side to the head (31h), is an open chamber (Ca) ventilated in the atmosphere.

The first slider (31a) also comprises a rod (31s), integral with the head, which is positioned through the seat (31b) and protrudes from the outside of the first sleeve (31c).

The first slider (31a) comprises a first inner channel (310) which emerges in the first chamber (31b). In particular, the first inner channel (310) is made through the first slider (31a) and, at one end, leads inside the first chamber (31b). At the other end, the first inner channel (310) can be connected to the circuit for feeding oil. According to the possible but not exclusive embodiment shown in FIG. 2, the first inner channel (310) is made at least partly through the rod (31s) of the first slider (31a). In this way, the pressure present in the first chamber (31b) produces a thrust which tends to pull the rod (31s), that is to say, put the rod in traction. This prevents the rod (31s) from bending.

In particular, as shown in FIG. 5a, the first inner channel (310) is made through the rod (31s), concentrically with the latter, and extends into the first chamber (31b) through one or more transversal openings (G). The first chamber (31b) is delimited by the head (31h), which slides in a sealed fashion in the sleeve (31c). The head (31h) prevents the oil from flowing into the open chamber (Ca), located on the opposite side with respect to the first chamber (31b). As already indicated, this determines that the pressure present in the first chamber (31b) produces a thrust which tends to pull the rod (31s), that is to say, put the rod in traction, preventing the rod (31s) from bending.

According to the preferred but non-exclusive embodiment illustrated, the second slider (32a) is substantially piston-shaped, like the first slider (31a), with a head (32h) slidable in a sealed fashion in the second sleeve (32c). The head (32h) substantially divides the volume inside the second sleeve (32c) into two separate chambers. One is the second chamber 31b. The other chamber, on the opposite side of the head (31h), is an open chamber (Ca) ventilated in the atmosphere.

According to the preferred but non-exclusive embodiment illustrated, the second slider (32a) comprises a second inner channel (320) which emerges in the second chamber (32b). In particular, the second inner channel (320) is made through the second slider (32a) and, at one end, leads inside the second chamber (32b). At the other end, the second inner channel (320) is connected to the first chamber (31b) of the first body (31). In other words, the first chamber (31b) is in fluid communication with the second inner channel (320).

According to the embodiment shown in FIG. 2, the second inner channel (320) is made at least partly through the rod (32s) of the second slider (32b). The rod (32s) is constrained to the first sleeve (31c). The second inner channel (320), at a first end, emerges in the first chamber (31b), whilst at the other end it emerges in the second chamber (32b). In turn, the second chamber (32b) is in communication with the re-entry chamber (23) of the second cylinder (C2). The emerging of the second inner channel (320) in the second chamber (32b) determines the fact that the pressure present in the second chamber (32b) produces a thrust which tends to pull the rod (32s) of the second slider (32a), that is, put the rod in traction. This prevents the rod (32s) from bending.

In particular, as shown in FIG. 5b, the second inner channel (320) is made through the rod (32s), concentrically with the latter, and emerges into the seat (32b) through one or more transversal openings (G), in the same way as described above with reference to the first inner channel (310). The second chamber (32b) is delimited by the head (32h), which slides in a sealed fashion in the second sleeve (32c). The head (32h) prevents the oil from flowing into the open chamber (Ca), located on the opposite side with respect to the second chamber (32b). As already indicated, this determines that the pressure present in the second chamber (32b) produces a thrust which tends to pull the rod (32s), that is to say, put the rod in traction, preventing the rod (32s) from bending.

The configuration described above of the outer conduit (31, 32) defines a feed/discharge channel for the re-entry chamber (23) of the second cylinder (C2). In practice, the oil flows through the first slider (31a), the first chamber (31b), the second slider (32a) and the second chamber (32b), in this order or in the reverse order, allowing a fluid connection between the extension chamber (23) and a source of pressurised fluid or a discharge source.

In particular, in the embodiment shown in FIG. 2, the feeding of oil to the extension chamber (23) of the second cylinder (C2) occurs by feeding the oil to the first inner conduit (310). From the first inner conduit (310), the oil flows to the first chamber (31b), and from there to the second inner channel (320), which is connected to the first chamber (31b). From the second inner channel (320) the oil flows to the second chamber (32b) and from there to the re-entry chamber (23) of the second cylinder (C2). This results in a relative sliding between the second piston (21) and the second jacket (A2). Since the second chamber (32b) of the second body (32) is integral with the second jacket (A2), the relative sliding between the second piston (21) and the second jacket (A2) determines a relative sliding between the second chamber (32b) and the second slider (32a). The feeding of oil to the extension chamber (21) of the second cylinder (C2) determines the discharge of oil from the re-entry chamber (23), with relative opposite flow and sliding with respect to those described above.

Moreover, in the case of relative sliding between the first piston (11) and the first jacket (A1), the first chamber (31b), which is integral with the first jacket (A1), is drawn in relative sliding with respect to the first slider (31a).

In short, any relative sliding between the first cylinder (C1) and the second cylinder (C2) pulls the first slider (31a) relative to the first chamber (31b) and/or the second slider (32a) relative to the second chamber (32b), adapting the length of the outer conduit (31, 32) to any relative sliding position between the first cylinder (C1) and the second cylinder (C2).

FIG. 3 shows an embodiment of the telescopic cylinder according to this invention. In this embodiment, the telescopic cylinder comprises a block (B) which constrains between them the second slider (32a) and the first sleeve (31c). In particular, the block (B) is constrained to the free end of the second slider (32a) and to the end of the first sleeve (31b) from which the first slider (31a) protrudes. The latter is arranged passing through the block (B), in such a way that the free end of the first slider (31a) can be connected to a manifold (T) which can be used for the connection to the oil feed circuit. The manifold (T) is connected to the first piston (11) and to the first slider (31a), in such a way that the latter is integral with the first piston (11) at least relative to the direct sliding parallel to the longitudinal axis (X).

The block (B) is provided with an inner channel which places in communication the second inner channel (320) and the first chamber (31b). The manifold (T) is provided with an inner channel that connects the first inner channel (310) with the oil feed circuit.

As shown in FIG. 4, the second sleeve (32c) is constrained to the second jacket (A2), whilst the first sleeve (31c) is associated with the second jacket (A2) with the possibility of sliding parallel to the longitudinal axis (X).

1. A telescopic cylinder, comprising:
a first cylinder, comprising a first piston slidable in a sealed fashion in a jacket which comprises an extension chamber and a re-entry chamber, separated from each other by a head of the first piston;
a second cylinder, comprising a second piston slidable in a sealed fashion in a second jacket which comprises an extension chamber and a re-entry chamber, separated from each other by a head of the second piston;
wherein the jacket of the first piston is integral with the second piston;
an outer conduit, connected to the re-entry chamber of the second cylinder for allowing the supply and discharge of oil;
wherein the outer conduit comprises:
a first body comprising a first slider slidable in a sealed fashion in a first sleeve which encloses a first chamber, the first sleeve being constrained to the second piston;
a second body, comprising a second slider slidable in a sealed fashion in a second sleeve which encloses a second chamber, said second sleeve being constrained to the second jacket, said second chamber being in fluid communication with the re-entry chamber of the second cylinder, said second slider being constrained to the first sleeve;
wherein the first slider comprises a first inner channel which emerges in the first chamber;
wherein the second slider comprises a second inner channel which emerges in the second chamber;
wherein the first chamber is in fluid communication with the second inner channel.

2. The telescopic cylinder according to claim 1, wherein the first slider comprises a first inner channel which, at one end, emerges in the first chamber, whilst at another end it may be connected to an oil supply circuit.

3. The telescopic cylinder according to claim 2, wherein the first slider comprises a head, slidable in a sealed fashion in the first sleeve, and a rod integral with the head, which is positioned through the first chamber and protrudes partly outside the first sleeve.

4. The telescopic cylinder according to claim 3, wherein the first inner channel is formed at least partly through the rod of the first slider.

5. The telescopic cylinder according to claim 1, wherein the second slider comprises a second inner channel which, at one end, emerges in the second chamber, whilst at another end it is connected to the first chamber of the first body

6. The telescopic cylinder according to claim 5, wherein the second slider comprises a head, slidable in a sealed fashion in the second sleeve, and a rod, integral with the head, which is positioned through the second chamber and protrudes partly outside the second sleeve.

7. The telescopic cylinder according to claim 6, wherein said rod of the second slider is connected to the first sleeve.

8. The telescopic cylinder according to claim 6, wherein the second inner channel is formed at least partly through the rod of the second slider

9. The telescopic cylinder according to claim 1, comprising a block which constrains between them the second slider and the first sleeve, wherein the first slider is positioned passing through the block, said block being provided with an inner channel which puts in communication the second inner channel and the first chamber.

10. The telescopic cylinder according to claim 1, comprising a manifold, connected to a free end of the first slider and provided with an inner channel which puts in communication the first inner channel with an oil supply and discharge circuit.
